(19) United States
(12) Patent Application Publication
(10) Pub. No.: US 2006/0207458 A1
(43) Pub. Date: Sep. 21, 2006

(54) Processless lithographic printing plates

(76) Inventors: Lambertus Groenendaal, Sinaai (BE); Hubertus Van Aert, Pulderbos (BE); Alexander Williamson, Mortsel (BE); Hieronymus Andriessen, Beerse (BE)

Correspondence Address: AGFA;c/o KEATING & BENNETT, LLP, 8180 GREENSBORO DRIVE, SUITE 850, MCLEAN, VA, 22102, US

(21) Appl. No.: 11/371,860

(22) Filed: Mar. 8, 2006

Related U.S. Application Data
(60) Provisional application No. 60/673,012, filed on Apr. 20, 2005.

(30) Foreign Application Priority Data
Mar. 21, 2005 (EP) 05102222.6

(51) Int. Cl. B41N 1/00

(52) U.S. Cl. 101/454

(57) ABSTRACT

A method of lithographic printing includes the steps of (i) providing a heat-sensitive lithographic printing plate precursor including, on a support having a hydrophilic surface or which is provided with a hydrophilic layer, a coating having a polymer modified with at least two groups which can form four hydrogen bonds, the groups being defined as quadruple hydrogen bonds (QHB groups); (ii) exposing the printing plate precursor to heat and/or infrared light whereby the coating switches from a hydrophilic state into a hydrophobic state or from a hydrophobic state into a hydrophilic state, thereby producing a lithographic printing master without an intermediate wet development step; and (iii) supplying ink and/or fountain solution to the lithographic printing master via a lithographic printing press.

### CROSS-REFERENCE TO RELATED PATENT APPLICATIONS

This application claims the benefit of U.S. Provisional Application No. 60/673,012 filed Apr. 20, 2005, which is incorporated by reference. In addition, this application claims the benefit of European Application No. 05102222.6 filed Mar. 21, 2005, which is also incorporated by reference.

### BACKGROUND OF THE INVENTION

1. Field of the Invention

The present invention relates to a method of lithographic printing and discloses a heat-sensitive printing plate precursor that is suitable for making a lithographic printing plate by direct-to-plate recording.

2. Description of the Related Art

Lithographic printing presses use a so-called printing master such as a printing plate which is mounted on a cylinder of the printing press. The master carries a lithographic image on its surface and a print is obtained by applying ink to the image and then transferring the ink from the master onto a receiver material, which is typically paper. In conventional, so-called “wet” lithographic printing, ink as well as an aqueous fountain solution (also called dampening liquid) are supplied to the lithographic image which consists of oleophilic (or hydrophobic, i.e. ink-accepting, water-repelling) areas as well as hydrophilic (or oleophobic, i.e. water-accepting, ink-repelling) areas. In so-called driographic printing, the lithographic image consists of ink-accepting and ink-abhesive (ink-repelling) areas and during driographic printing, only ink is supplied to the master.

Printing masters are generally obtained by the image-wise exposure and processing of an imaging material called a plate precursor. In addition to the well-known photosensitive, so-called pre-sensitized plates, which are suitable for UV contact exposure through a film mask, heat-sensitive printing plate precursors have also become very popular in the late 1990s. Such thermal materials offer the advantage of daylight stability and are especially used in the so-called computer-to-plate method wherein the plate precursor is directly exposed, i.e., without the use of a film mask. The material is exposed to heat or to infrared light and the generated heat triggers a (physico-) chemical process, such as ablation, polymerization, insolubilization by cross linking of a polymer, heat-induced solubilization, or by particle coagulation of a thermoplastic polymer latex.

The most popular thermal plates form an image by a heat-induced solubility difference in an alkaline developer between exposed and non-exposed areas of the coating. The coating typically includes an oleophilic binder, e.g. a phenolic resin, of which the rate of dissolution in the developer is either reduced (negative working) or increased (positive working) by the image-wise exposure. During processing, the solubility differential leads to the removal of the non-image (non-printing) areas of the coating, thereby revealing the hydrophilic support, while the image (printing) areas of the coating remain on the support. Typical examples of such plates are described in, e.g., EP 625 728, EP 823 327, EP 825 927, EP 864 420, EP 894 622 and EP 901 902. Negative working embodiments of such thermal materials often require a pre-heat step between exposure and development as described in, e.g., EP 625 728.

Some of these thermal processes enable plate making without wet processing and are, for example, based on ablation of one or more layers of the coating. At the exposed areas, the surface of an underlying layer is revealed which has a different affinity towards ink or fountain solution than the surface of the unexposed coating, thus the image (printing) and non-image or background (non-printing) areas are obtained.

U.S. Pat. No. 5,605,780 discloses a lithographic printing plate including an anodized aluminum support and an image-forming layer having an IR absorbing agent and a cyanoacrylate polymer binder provided on the anodized alminum support. The image-forming layer is removed by laser-induced thermal ablation whereby the underlying hydrophilic support is revealed.

EP 580 393 discloses a lithographic printing plate directly imageable by laser discharge, the plate including a topmost first layer and a second layer underlying the first layer, wherein the first layer is characterized by efficient absorption of infrared radiation and the first and second layer exhibit different affinities for at least one printing liquid.

EP 1 065 051 discloses a negative-working heat-sensitive material for making lithographic plates including, in the order given, a lithographic base having a hydrophilic surface, an oleophilic imaging layer, and a cross-linked hydrophilic upper layer. The heat generated during exposure in the light-sensitive layer removes the hydrophilic upper layer by ablation.

Most ablative plates generate ablation debris which may contaminate the electronics and optics of the exposure device and which needs to be removed from the plate by wiping it with a cleaning solvent, so that ablative plates are often not truly processless. Ablation debris which is deposited onto the plate's surface may also interfere with the printing process and result in, for example, scumming.

Other thermal processes which enable plate making without wet processing are, for example, processes based on a heat-induced hydrophilic/oleophilic conversion of one or more layers of the coating so that at exposed areas a different affinity towards ink or fountain solution is created than at the surface of the unexposed coating. Such coatings include heat-switchable inorganic materials, e.g. zirconia ceramics (U.S. Pat. No. 5,855,173, U.S. Pat. No. 5,839,369 and U.S. Pat. No. 5,839,370) or metal oxides (EP 903 223 and U.S. Pat. No. 6,455,222), or organic polymers as described in EP 924 102, WO 92/09934, EP 652 483, U.S. Pat. No. 4,081,572, EP 200 488 and EP 924 065.

WO98/14504 and the doctoral thesis “New Polymers Based On The Quadruple Hydrogen Bonding Motif” of B. J. B. Folmer, Technische Universiteit Eindhoven, 2000, disclose supramolecular polymers containing monomeric units that are bonded in the supramolecular polymer on at least one side via covalent bonds and that can form at least four hydrogen bridges with each other.

WO 02/053626, WO/053627 and U.S. Pat. No. 6,506,536 disclose an imageable element including a thermally sensitive polymer including at least one covalently bonded unit and at least one non-covalently bonded unit which includes two or more centered H-bonds. The thermally sensitive polymer exhibits an increased solubility in an aqueous developer solution upon heating.

US 2004/0023155 discloses an imaging element having supramolecular polymers which include QHB-modified (quadruple hydrogen bond-modified) polymeric molecules linked via hydrogen bridges. The QHB-modified polymeric molecules include two QHB-modified portions A and B, which are linked via a linking group and wherein the A and B portions are selected from a phenolic, acrylic, polyester or polyurethane resin. Upon heating of the imaging element, the QHB-modified polymeric molecules become soluble in an alkaline developer.

### SUMMARY OF THE INVENTION

In order to overcome the problems described above, preferred embodiments of the present invention provide an alternative printing plate precursor for making a heat-sensitive Lithographic printing plate which requires no wet processing step and which can be directly exposed to heat and/or light by a laser with low power output.

Surprisingly, it was discovered that the coating of the heat-sensitive lithographic printing plate precursor according to a method of a preferred embodiment of the present invention, switches from a hydrophilic state to a hydrophobic state or from a hydrophobic state to a hydrophilic state upon exposure to heat. After exposure, the printing plate is ready for printing without the need for further development.

According to the present preferred embodiment there is provided a method of lithographic printing including the steps of:
(i) providing a heat-sensitive lithographic printing plate precursor including, on a support having a hydrophilic surface or which is provided with a hydrophilic layer, a coating including a polymer modified with at least two groups which can form four hydrogen bonds, the groups being defined as quadruple hydrogen bonds (QHB groups);
(ii) exposing the printing plate precursor to heat and/or infrared light whereby the coating switches from a hydrophilic state into a hydrophobic state or from a hydrophobic state into a hydrophilic state, thereby producing a lithographic printing master without an intermediate wet development step; and
(iii) supplying ink and/or fountain solution to the lithographic printing master via a lithographic printing press.

According to another preferred embodiment there is also provided a printing plate precursor including, on a support having a hydrophilic surface or which is provided with a hydrophilic layer, a coating including a polyether modified with at least two groups which can form four hydrogen bonds, the groups being defined as quadruple hydrogen bonds (QHB groups).

Other features, elements, steps, characteristics and advantages of the present invention will become more apparent from the following detailed description of preferred embodiments of the present invention.

### DETAILED DESCRIPTION OF PREFERRED EMBODIMENTS

The coating of the printing plate precursor according to the method of one of the preferred embodiments of the present invention includes a polymer having at least two QHB groups, hereinafter also referred to as a QHB-modified polymer. The QHB groups are attached to the polymer by covalent bonds, and these QHB groups may be identical to each other or may be different from each other.

A QHB group is a group capable of forming four hydrogen bonds (i.e., Quadruple Hydrogen Bonds or QHB) and can thus be linked via at least four hydrogen bonds to another QHB group. Preferably the QHB group includes two donor sites and two acceptor sites and the hydrogen bonds are preferably oriented parallel or substantially parallel to one another. The QHB group preferably has an essentially flat rigid structure such as, for example, a flat six-membered ring. A preferred QHB group is an isocytosinyl group.

According to the present preferred embodiment, a QHB group present on a polymer can associate with a QHB group present on another polymer and a structure with 4-centered hydrogen bonded units is obtained. A schematic presentation of such an association is shown hereafter:

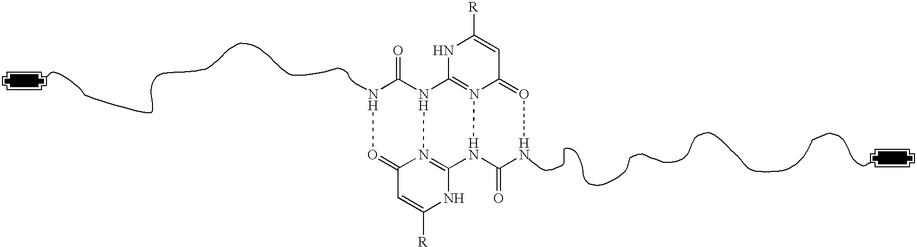

Each QHB group present on the modified polymer can form such a structure and a so-called ‘supramolecular polymer’ is obtained. Thus, the term “supramolecular polymer” in the context of the present preferred embodiment refers to a polymer which derives its polymeric properties through a combination of covalent bonds and secondary interactions including hydrogen bonds, more specificly four centered hydrogen bonds or quadruple hydrogen bonds (QHB). Such secondary interactions provide high bond strengths and substantially affect the properties of the modified polymers. Between the QHB units other secondary interactions besides hydrogen bonds such as Van der Waals associations, hydrophobic associations, ionic associations or combinations thereof, may also be present. A schematic presentation of a ‘supramolecular polymer’ is shown hereafter:

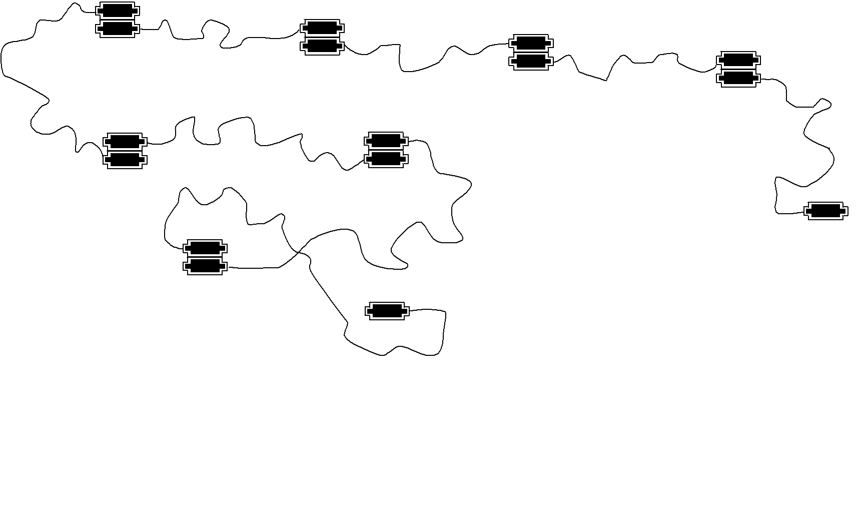

The polymer including at least two QHB groups is preferably selected from phenolic resins, (meth)acrylic resins; polyester resins, polyether resins, polyurethane resins or mixtures and copolymers thereof.

A QHB-modified polymer can be prepared by reaction of, for example, an isocytosine such as a 6-alkyl isocytosine, typically 6- methyl isocytosine, with an isocyanate to produce an isocytosine/isocyanate mono-adduct, i.e. a quadruple hydrogen bonding entity (QHBE). The quadruple hydrogen bonding entity may react with the appropriate polymer to produce the QHB-modified polymer. The 6-methyl isocytosine/isocyanate mono-adduct, a QHBE, is represented by the formula:

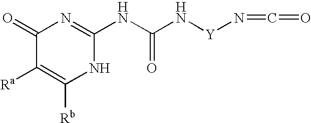

in which R^{a} is hydrogen, R^{b} is methyl, and Y is an alkylene group derived from a diisocyanate represented by the formula Y(NCO)₂.

Reaction of one mole of the isocytosine with one mole of the diisocyanate produces the QHBE, which will spontaneously dimerize to form a dimeric mono-adduct joined by four thermally reversible hydrogen bonds. The resulting dimeric QHBE has a free isocyanate group on each end, which can react with the appropriate polymer such as a (meth)acrylic polymer, a phenolic polymer, a polyester polymer, a polyether polymer or a polyurethane polymer to produce a QHB-modified polymer such as QHB-modified (meth)acrylic polymer, a QHB-modified phenolic polymer, a QHB-modified polyester polymer, a QHB-modified polyether polymer or a QHB-modified polyurethane polymer.

An alternative method to prepare a QBH-containing polymer is by homopolymerisation of a vinyl monomeric unit containing a QHB group. QBH-containing copolymers can be obtained by copolymerisation of a vinyl monomeric unit containing a QHB group with other vinyl monomeric units.

Carboxyl substituted acrylic polymers may be used as the acrylic polymer. These include, for example, polymers and copolymers of acrylic acid and/or methacrylic acid with, for example, alkyl esters of acrylic acid such as methyl acrylate and ethyl acrylate; alkyl esters of methacrylic acid such as methyl methacrylate and ethyl methacrylate; hydroxyethyl acrylate; hydroxyethyl methacrylate, hydroxypropyl acrylate, hydroxypropyl methacrylate; amides of acrylic acid such as acrylamide and N-methylacrylamide; amides of methacrylic acid such as methacrylamide and N-methylmethacrylamide; acrylonitrile; methacrylonitrile; vinyl chloride; maleic anhydride; itoconic acid; vinylidene chloride; vinyl acetate; vinyl ether; styrene; and N-phenylmaleimide.

In a preferred embodiment, the printing plate precursor preferably includes a polymethacrylate or polyacrylate homopolymer or copolymer which includes a recurring unit containing a covalently bonded isocytosinyl group in the side chain. The recurring units of the polymethacrylate or polyacrylate homopolymer or copolymer may be represented by the following structures:

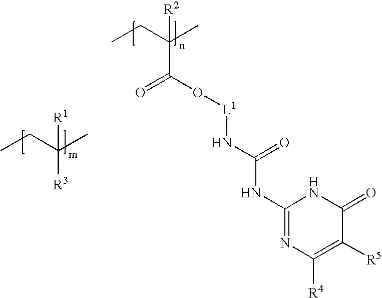

wherein

R¹ and R² independently represent hydrogen or a hydrocarbon group having up to 12 carbon atoms;

R³ represents hydrogen, an alkyl group, a fluoroalkyl group, an optionally substituted phenyl group, an optionally substituted benzyl group, a pyridyl group, —OR, —COR, —COOR, —OCOR, —NHR, —CONHR, —NHCOR, —NHCOOR, —OCONHR, —NH—CO—NHR or combinations thereof, wherein R represents hydrogen, an optionally substituted alkyl, aryl or a heteroaryl group;

R⁴ and R⁵ independently represent hydrogen, a halogen, an alkoxy or an optionally substituted alkyl, aryl or heteroaryl group;

L¹ represents a divalent linking group; and

m/n varies from about 100 to 0 and the molecular weight is preferably between about 500 g/mol and about 500,000 g/mol.

The substituents optionally present in the phenyl or benzyl groups of R³ may independently be represented by an alkyl group, a halogen such as a chlorine or bromine atom, a carboxylic acid, a sulphonic acid, or a phosphonic acid group, or salts thereof, or a hydroxyl group. The substituents optionally present in the alkyl, aryl or heteroaryl groups of R, R⁴ and R⁵ may independently be represented by a halogen such as a chlorine or bromine atom, a carboxylic acid, a sulphonic acid, or a phosphonic acid group, or salts thereof or a hydroxyl group.

The divalent linking group L¹ represents an alkylene group such as a methylene group, an ethylene group, a propylene group, a butylene group, an isopropylene group, a cycloalkylene group such as cyclohexylene group, an arylene group such as a tolylene group or a heteroarylene group.

More preferably, the recurring units of the polymethacrylate or polyacrylate homopolymer or copolymer may be represented by the following structures:

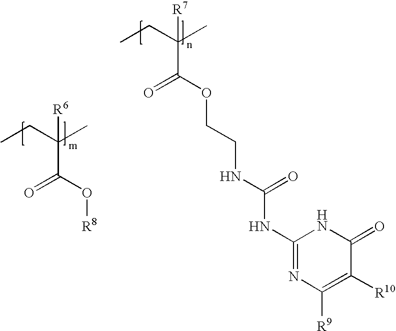

wherein

R⁶ and R⁷ independently represent hydrogen or a hydrocarbon group having up to 12 carbon atoms;

R⁸ represents hydrogen, an optionally substituted alkyl, aryl or heteroaryl group;

R⁹ and R¹⁰ independently represent hydrogen, a halogen, an alkoxy or an optionally substituted alkyl, aryl or heteroaryl group; and

m/n varies from about 100 to 0, more preferably between about 50 to about 0.01, most preferably between about 10 and about 0.5; and the molecular weight is preferably between about 500 g/mol and about 500,000 g/mol, more preferably between about 800 g/mol and about 100,000 g/mol, and most preferably between about 900 g/mol and about 80,000 g/mol.

The substituents optionally present in the alkyl, aryl or heteroaryl groups of R⁸, R⁹ and R¹⁰ may independently be represented by a halogen such as a chlorine or bromine atom, a carboxylic acid, a sulphonic acid, or a phosphonic acid group, or salts thereof, or a hydroxyl group.

Specific preferred structures of the polymethacrylate or polyacrylate copolymer may be represented by the following compounds I:

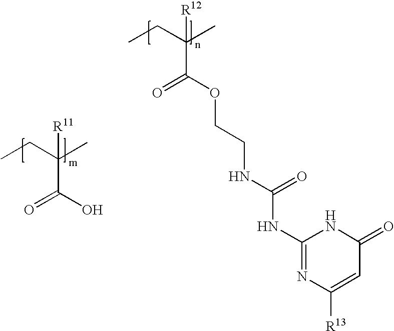

Compound I-1

R¹¹═R¹²═R¹³=Me;

m/n=10;

Mn=1000-50,000 g/mol

Compound I-2

R¹¹═R¹²═R¹³=Me;

m/n=5.67;

Mn=1000-50,000 g/mol

Compound I-3

R¹¹═R¹²═R¹³=Me;

m/n=4;

Mn=1000-50,000 g/mol

Compound I-4

R¹¹═R¹²═R¹³=Me;

m/n=2.33;

Mn=1000-50,000 g/mol

Compound I-5

R¹¹═H;

R¹²═R¹³=Me;

m/n=10;

Mn=1000-50,000 g/mol

Compound I-6

R¹¹═H;

R¹²═R¹³=Me;

m/n=5.67;

Mn=1000-50,000 g/mol

Compound I-7

R¹¹═H;

R¹²═R¹³=Me;

m/n=4;

Mn=1000-50,000 g/mol

Compound I-8

R¹¹═H;

R¹²═R¹³=Me;

m/n=2.33;

Mn=1000-50,000 g/mol

Phenolic polymers are typically film-forming polymeric materials that have a multiplicity of phenolic hydroxyl groups either on the polymer backbone or on pendant groups. Novolac resins, resol resins, acrylic resins that contain pendent phenol groups, and polyvinyl phenolic resins are preferred phenolic resins. Other useful phenolic resins include polyvinyl compounds having phenolic hydroxyl groups. Such compounds include, for example, polyhydroxystyrenes and copolymers containing recurring units of a hydroxystyrene, and polymers and copolymers containing recurring units of substituted hydroxystyrenes.

Novolac resins are more preferred. Novolac resins are commercially available and are well known to those skilled in the art. They are typically prepared by the condensation reaction of a phenol, such as phenol, m-cresol, o-cresol, p-cresol, etc, with an aldehyde, such as formaldehyde, paraformaldehyde, acetaldehyde, etc. or a ketone, such as acetone, in the presence of an acid catalyst. The weight average molecular weight is typically about 1,000 g/mol to about 15,000 g/mol. Typical novolac resins include, for example, phenol-formaldehyde resins, cresol-formaldehyde resins, phenol-cresol-formaldehyde resins, p-t-butylphenol-formaldehyde resins, and pyrogallol-acetone resins.

Useful polyester polymers may be prepared by reaction of dianhydride compounds with hydroxyl-containing polyester precursors composed of dicarboxylic acid units and glycol units. Useful hydroxyl-containing polyester precursors include, for example, oligoester diols which are the reaction product of a dicarboxylic acid such as succinic acid, adipic acid, azelaic acid, sebacic acid, phthalic acid, isophthalic acid, terephthalic acid, tetrahydrophthalic acid, hexahydrophthalic acid, tetrabromophthalic acid, tetrachlorophthalic acid, 1,4-cyclohexanedicarboxylic acid, maleic acid, fumaric acid, itaconic acid and 5-sodiumsulfoisophthalic acid, with a diol such as ethylene glycol, diethylene glycol, triethylene glycol, polyethylene glycol, 1,2- or 1,3-propanediol, polypropylene glycol, 1,2- or 1,4-butanediol, neopentyl glycol, or 1,6-hexanediol. Useful dianhydrides include, for example, pyromellitic dianhydride, 3,3′, 4,4′-benzophenone tetracarboxylic dianhydride, 3,3′, 4,4′-diphenyl tetracarboxylic dianhydride, or 2,3,6,7-naphthalene tetracarboxylic dianhydride.

Useful polyurethane polymers may be prepared by reaction of carboxyl functional diols with diisocyanates. Useful carboxyl functional diols include, for example, dimethylol propionic acid, dihydroxybenzoic acids and the reaction product of a dianhydride such as pyromellitic dianhydride, 3,3′, 4,4′-benzophenone tetracarboxylic dianhydride, 3,3′, 4,4′-diphenyl tetracarboxylic dianhydride, or 2,3,6,7-naphthalene tetracarboxylic dianhydride with a diol such as ethylene glycol, diethylene glycol, triethylene glycol, polyethylene glycol, 1,2- or 1,3- propanediol, polypropylene glycol, 1,2- or 1,4-butanediol, neopentyl glycol, or 1,6-hexanediol.

Useful polyethers are preferably selected from linear, cyclic or branched polyalkyleneoxides such as for example polyethylene oxide, polypropylene oxide, polybutyleneoxide or mixtures and copolymers thereof. A preferred polyether is a copolymer including ethylene oxide and propylene oxide. The polyalkylene oxides preferably include one or more units of the formula —CₙH₂ₙ—O— wherein n is preferably an integer in the range of 2 to 5. The moiety —CₙH₂ₙ— may include straight or branched chains. The alkylene moiety may also include optional substituents. The molecular weight of the polyether is preferably between about 100 g/mol and about 5000 g/mol, more preferably between about 150 g/mol and about 2,000 g/mol, and most preferably between about 150 g/mol and about 1,500 g/mol.

In another preferred embodiment, the printing plate precursor preferably includes a QHB-modified polyether. A preferred QHB-modified polyether may be represented by the following structure:

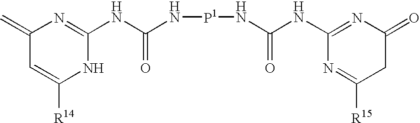

wherein

R¹⁴ and R¹⁵ are independently selected from hydrogen, a halogen, a hydroxyl, an alkoxy or an optionally substituted alkyl, aryl or heteroaryl group; and

and P¹ is a divalent group including a polyether group as described above.

The substituents optionally present in the alkyl, aryl or heteroaryl groups of R¹⁴ and R¹⁵ may independently be represented by a halogen such as a chlorine or bromine atom, a carboxylic acid, a sulphonic acid, or a phosphonic acid group, or salts thereof, or a hydroxyl group.

More preferred QHB-modified polyethers are represented by the following structure:

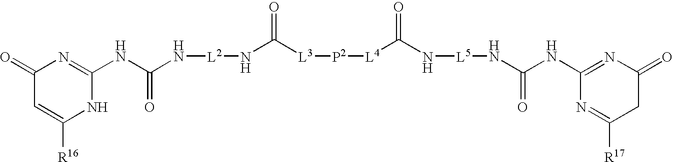

wherein

R¹⁶ and R¹⁷ are independently selected from hydrogen, a halogen, a hydroxyl, an alkoxy or an optionally substituted alkyl, aryl or heteroaryl group;

L², L³, L⁴ and L⁵ each independently represent a divalent linking group; and

P² is a divalent group including a polyether group as described above.

The substituents optionally present in the alkyl, aryl or heteroaryl groups of R¹⁶ and R¹⁷ may independently be represented by a halogen such as a chlorine or bromine atom, a carboxylic acid, a sulphonic acid, or a phosphonic acid group, or salts thereof, or a hydroxyl group.

The divalent linking groups L² and L⁵ represent an alkylene group such as a methylene group, an ethylene group, a propylene group, a butylene group, an isopropylene group; a cycloalkylene group such as cyclohexylene group; an arylene group such as a tolylene group, a heteroarylene group.

The divalent linking groups L³ and L⁴ represent an alkylene group such as a methylene group, an ethylene group, a propylene group, a butylene group, an isopropylene group; a cycloalkylene group such as cyclohexylene group; an arylene group such as a tolylene group, a heteroarylene group, —O—, —O—CO—, —NH—, —O—(CH₂)ₖ—, —(CH₂)ₖ—O—, —(CH₂)ₖ—O—CO—, —O—CO—(CH₂)ₖ—, —(CH₂)ₖ—O—CO—(CH₂)ₗ—, —(CH₂)ₖ—COO—, —CO—O—(CH₂)ₖ—, —(CH₂)ₖ—COO—(CH₂)ₗ—, —(CH₂)ₖ—NH—, —NH—(CH₂)ₖ—, —(CH₂)ₖ—CONH—, —NH—(CH₂)ₖ—O—(CH₂)ₗ—, —(CH₂)ₖ—CO—, —NH—CO—, —NH—CO—O—, —O—CO—NH, —(CH₂)ₖ—CO—NH—, —NH—CO—(CH₂)ₖ—, —NH—CO—NH— or combinations thereof wherein k and l are independently an integer greater or equal to 1.

Specific examples of QHB-modified polyethers that are preferred include the following compounds II:

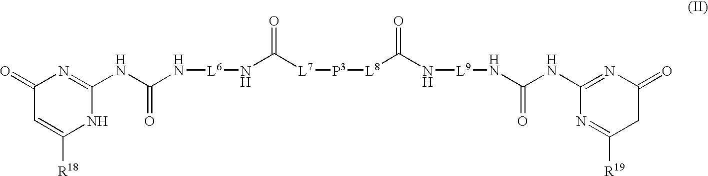

Compound II-1

R¹⁸═R¹⁹═CH₃

L⁶=L⁹=—(CH₂)₆—

L⁷=L⁸=—O—

P³=polyethyleneoxide (Mn=200 g/mol)

Compound II-2

R¹⁸═R¹⁹═H

L⁶=L⁹=—(CH₂)₆—

L⁷=L⁸=—O—

P³=polyethyleneoxide (Mn=200 g/mol)

Compound II-3

R¹⁸═R¹⁹═CH₃

L⁶=L⁹=—(CH₂)₆—

L⁷=L⁸=—O—

P=polyethyleneoxide (Mn=300 g/mol)

Compound II-4

R¹⁸═R¹⁹═CH₃

L⁶=L⁹=—(CH₂)₆—

L⁷=L⁸=—O—

P³=polyethyleneoxide (Mn=400 g/mol)

Compound II-5

R¹⁸═R¹⁹═CH₃

L⁶=L⁹—(CH₂)₆—

L⁷=L⁸=—O—

P³=polyethyleneoxide (Mn=900 g/mol)

Compound II-6

R¹⁸═R¹⁹═CH₃

L⁶=L⁹=-(CH₂)₆—

L⁷=L⁸=-O—

P³=polyethyleneoxide (Mn=1000 g/mol)

Compound II-7

R¹⁸═R¹⁹═CH₃

L⁶=L⁹=—(CH₂)₆—

L⁷=L⁸=—NH—

P³=polyethylene oxide-co-polypropylene oxide (Mn=600 g/mol)

Compound II-8

R¹⁸═R¹⁹═CH₃

L⁶=L⁹=—(CH₂)₆—

L⁷=L⁸=—NH—

P³=polypropylene oxide (Mn=230 g/mol)

Compound II-9

R¹⁸═R¹⁹═CH₃

L⁶=L⁹=2,4,4-trimethylhexamethylene

L⁷=L⁸=—O—

P³=polyethyleneoxide (Mn=400 g/mol)

Compound II-10

R¹⁸═R¹⁹═CH₃

L⁶=L⁹=—(CH₂)₆—

L⁷=L⁸=—O—

P³=polypropyleneoxide (Mn=425 g/mol)

Preferably, the printing plate precursor further includes a monofunctional compound, i.e., a compound including one QHB group. More preferably, the monofunctional compound is a QHB-modified polyether. The polyether is preferably a polymer including straight, branched or cyclic alkylene oxide units such as ethylene oxide or propylene oxide units or mixtures thereof with a molecular weight varying preferably from about 100 g/mol to about 5,000 g/mol, more preferably between about 150 g/mol and about 2,000 g/mol, and most preferably between about 150 g/mol and about 1,500 g/mol.

Specific monofunctional compounds are represented by the following compounds III or VI:

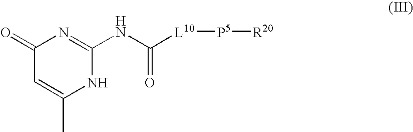

Compound III-1

L¹⁰=—O—

P⁵=polyethylene oxide, Mn=400 g/mol

R²⁰═OH

Compound III-2

L¹⁰=—NH—

P⁵=polyethylene oxide-co-polypropylene oxide (Mn=600 g/mol)

R²⁰═NH₂

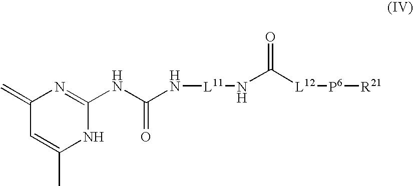

Compound IV-1

L¹¹=—(CH₂)₆—

L¹²=—O—

P⁶=polyethylene oxide (Mn=400 g/mol)

R²¹═OH

Compound IV-2

L¹¹=—(CH₂)₆—

L¹²=—NH—

P⁶=polyethylene oxide-co-polypropylene oxide (Mn=600 g/mol)

R²¹═NH₂

According to another preferred embodiment there is also provided a printing plate precursor including a QHB-modified polyether as described above. Optionally, the printing plate precursor may also include a monofunctional compound as described above.

The support of the lithographic printing plate precursor preferably has a hydrophilic surface or is provided with a hydrophilic layer. The support may be a sheet-like material such as a plate or it may be a cylindrical element such as a sleeve that can be slid around a print cylinder of a printing press. Preferably, the support is a metal support such as aluminum or stainless steel.

A particularly preferred lithographic support is an electrochemically grained and anodized aluminum support. The anodized aluminum support may be treated to improve the hydrophilic properties of its surface. For example, the aluminum support may be silicated by treating its surface with a sodium silicate solution at an elevated temperature, e.g., about 95° C. Alternatively, a phosphate treatment may be applied which involves treating the aluminum oxide surface with a phosphate solution that may further contain an inorganic fluoride. Further, the aluminum oxide surface may be rinsed with a citric acid or citrate solution. This treatment may be carried out at room temperature or may be carried out at a slightly elevated temperature of about 30° C. to about 50° C. A further interesting treatment involves rinsing the aluminum oxide surface with a bicarbonate solution. Still further, the aluminum oxide surface may be treated with polyvinylphosphonic acid, polyvinylmethylphosphonic acid, phosphoric acid esters of polyvinyl alcohol, polyvinylsulfonic acid, polyvinylbenzenesulfonic acid, sulfuric acid esters of polyvinyl alcohol, and acetals of polyvinyl alcohols formed by reaction with a sulfonated aliphatic aldehyde. It is further evident that one or more of these post treatments may be carried out alone or in combination. More detailed descriptions of these treatments are given in GB 1,084,070, DE 4,423,140, DE 4 417 907, EP 659 909, EP 537 633, DE 4 001 466, EP 292 801, EP 291 760 and U.S. Pat. No. 4,458,005.

According to another preferred embodiment of the present invention, the support can also be a flexible support, which is provided with a hydrophilic layer, hereinafter called ‘base layer’. The flexible support is, e.g., paper, plastic film, thin aluminum or a laminate thereof. Preferred examples of plastic film are polyethylene terephthalate film, polyethylene naphthalate film, cellulose acetate film, polystyrene film, polycarbonate film, etc. The plastic film support may be opaque or transparent.

The base layer is preferably a cross-linked hydrophilic layer obtained from a hydrophilic binder cross-linked with a hardening agent such as formaldehyde, glyoxal, polyisocyanate or a hydrolyzed tetra-alkylorthosilicate. The latter is particularly preferred. The thickness of the hydrophilic base layer may vary in the range of about 0.2 μm to about 25 μm and is preferably about 1 μm to about 10 μm.

Particular examples of suitable hydrophilic base layers for use in accordance with the present preferred embodiment are disclosed in EP 601 240, GB 1,419,512, FR 2,300,354, U.S. Pat. No. 3,971,660, and U.S. Pat. No. 4,284,705.

The coating preferably also contains a compound that absorbs infrared light and converts the absorbed energy into heat. The amount of infrared absorbing agent in the coating is preferably between about 0.25 and about 25.0% by weight, more preferably between about 0.5 and about 20.0% by weight. In a preferred embodiment, its concentration is at least about 6% by weight, more preferably at least about 8% by weight. The infrared absorbing compound can be present in the image-recording layer and/or an optional other layer. Preferred IR absorbing compounds are dyes such as cyanine, merocyanine, indoaniline, oxonol, pyrilium and squarilium dyes or pigments such as carbon black. Examples of suitable IR absorbers are described in e.g. EP 823 327, EP 978 376, EP 1 029 667, EP 1 053 868, EP 1 093 934, WO 97/39894 and WO 00/29214. A preferred compound is the following cyanine dye IR-1:

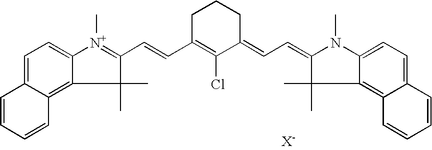

wherein X⁻ is a suitable counter ion such as tosylate, bromide or chloride.

To protect the surface of the coating, in particular from mechanical damage, a protective layer may also optionally be applied. The protective layer generally includes at least one water-soluble polymeric binder, such as polyvinyl alcohol, polyvinylpyrrolidone, partially hydrolyzed polyvinyl acetates, gelatin, carbohydrates or hydroxyethylcellulose, and can be produced in any known manner such as from an aqueous solution or dispersion which may, if required, contain small amounts, i.e., less than about 5% by weight, based on the total weight of the coating solvents for the protective layer, of organic solvents. The thickness of the protective layer can suitably be any amount, advantageously up to about 5.0 μm, preferably from about 0.05 μm to about 3.0 μm, and particularly preferably from about 0.10 μm to about 1.0 μm.

The coating may, in addition to the image-recording layer, also contain one or more additional layer(s). Besides the additional layers already discussed above, i.e., an optional light-absorbing layer including one or more compounds that are capable of converting infrared light into heat and/or a protective layer such as, e.g., a covering layer which is removed during processing—the coating may further for example inlcude an adhesion-improving layer between the image-recording layer and the support.

Optionally, the layer including a compound capable of absorbing light or an optional other layer may further contain additional ingredients. For example, binders, surfactants such as perfluoro surfactants, silicon or titanium dioxide particles or colorants may be present.

According to the method of the present preferred embodiment, the heat-sensitive printing plate precursor obtained is image-wise exposed directly with heat or indirectly with infrared light, preferably near infrared light. The infrared light is preferably converted into heat by an IR light absorbing compound as discussed above. The printing plate precursor is not sensitive to ambient light so that it can be handled without the need for a safe light environment.

The printing plate precursor can be exposed to infrared light by means of, e.g., LEDs or an infrared laser. Preferably, the light used for the exposure is a laser emitting near infrared light having a wavelength in the range from about 700 nm to about 1,500 nm, e.g. a semiconductor laser diode, a Nd:YAG or a Nd:YLF laser. The required laser power depends on the sensitivity of the image-recording layer, the pixel dwell time of the laser beam, which is determined by the spot diameter (typical value of modern plate-setters at 1/e² of maximum intensity: about 10-25 μm), the scan speed and the resolution of the exposure apparatus (i.e., the number of addressable pixels per unit of linear distance, often expressed in dots per inch or dpi; typical value: about 1,000-4,000 dpi).

Two types of laser-exposure apparatuses are commonly used: internal (ITD) and external drum (XTD) plate-setters. ITD plate-setters for thermal plates are typically characterized by a very high scan speed up to 1,500 m/sec and may require a laser power of several Watts. The Agfa GALILEO T (trademark of Agfa Gevaert N.V.) is a typical example of a plate-setter using the ITD-technology. XTD plate-setters operate at a lower scan speed typically from about 0.1 m/sec to about 20 m/sec and have a typical laser-output-power per beam from about 20 mW up to about 500 mW. The Creo TRENDSETTER plate-setter family (trademark of Creo) and the Agfa EXCALIBUR plate-setter family (trademark of Agfa Gevaert N.V.) both make use of the XTD-technology.

The known plate-setters can be used as an off-press exposure apparatus, which offers the benefit of reduced press down-time. XTD plate-setter configurations can also be used for on-press exposure, offering the benefit of immediate registration in a multi-color press. More technical details of on-press exposure apparatuses are described in, e.g., U.S. Pat. No. 5,174,205 and U.S. Pat. No. 5,163,368.

The exposure step may optionally be followed by a rinsing step and/or a gumming step. The gumming step involves post-treatment of the heat-sensitive printing plate with a gum solution. A gum solution is typically an aqueous liquid that includes one or more surface protective compounds that are capable of protecting the lithographic image of a heat-sensitive material or printing plate against contamination or damaging. Suitable examples of such compounds are film-forming hydrophilic polymers or surfactants.

The heat-sensitive printing plate is then ready for printing without an additional development step. The exposed plate can be mounted on a conventional, so-called wet offset printing press in which ink and an aqueous dampening liquid are supplied to the material. The non-image areas hold the dampening water and the image areas hold the ink.

Another suitable printing method uses so-called single-fluid ink without a dampening liquid. Suitable single-fluid inks have been described in U.S. Pat. No. 4,045,232, U.S. Pat. No. 4,981,517 and U.S. Pat. No. 6,140,392. In a preferred embodiment, the single-fluid ink includes an ink phase, also called the hydrophobic or oleophilic phase, and a polyol phase as described in WO 00/32705.

Alternatively, the printing plate is first mounted on the printing cylinder of the printing press and then image-wise exposed directly on the press via an integrated image-recording device. Subsequent to exposure, the plate is ready for printing.

The printing plate precursor according to the present preferred embodiment including the QHB-modified polyether may be exposed and optionally post-treated with a gum solution or water (both steps as described in detail above) whereby a printing master is obtained. The printing step can be carried out as described above.

### EXAMPLES

Preparation of the Compounds

The chemicals used in the synthesis described below are commercially available. The preparation method of 4-cyano-4-[(phenylthioxomethyl)thio]pentanoic acid is described in S. H. Thang, B. Y. K. Chong, R. T. A. Mayadunne, G. Moad, E. Rizzardo, Tet. Lett., 1999, 40, 2435.

1.1. Preparation of Compounds I-3, I-6 and I-7.

### Preparation of 2-methyl-, 2-[[[(1,4-dihydro-6-methyl-4-oxo-2-pyrimidinyl)amino]carbonyl]amino]ethyl methacrylate

5.0 g 2-Amino-4-hydroxy-6-methylpyrimidine was dissolved in 65 ml dimethylsulphoxide by heating to 170 ° C. To the solution 6.8 g isocyanatoethylmethacrylate was added. The mixture was stirred for 20 minutes and then cooled in an ice-bath. The resultant precipitate was diluted with acetone and then filtered to give the desired product. Yield=7.0 g, 78%.

Preparation of Compound I-7.

Into a half litre three-necked flask 1.52 g acrylic acid, 1.48 g 2-methyl-, 2-[[[(1,4-dihydro-6-methyl-4-oxo-2-pyrimidinyl)amino]carbonyl]amino]ethyl methacrylate and 25 ml 1-methoxy-2-propanol were added. Subsequently, 0.074 g 4-cyano-4-[(phenylthioxomethyl)thio]pentanoic acid and 0.067 g 4,4′-Azobis(4-cyanovaleric acid) were added to this solution. The solution was then degassed by bubbling nitrogen through for 60 minutes. The polymerisation was started by warming the mixture up to 85° C. and was kept at this temperature for 5 hours. The mixture was then allowed to cool down. The precipitate was filtered off, washed with methylene chloride and then dried. Yield=2.19 g, 73%, Mn=11310 g/mol.

Preparation of Compound I-3.

I-3 was made by the same method as compound I-7, with the following amounts of starting materials. Methacrylic acid (2.21 g), 2-[[[(1,4-dihydro-6-methyl-4-oxo-2-pyrimidinyl)amino]carbonyl]amino]ethyl methacrylate (1.79 g), methoxypropanol (40 mL), 4-cyano-4-[(phenylthioxomethyl)thio]pentanoic acid (0.081 g), 4,4′-Azobis(4-cyanovaleric acid) (0.081 g). Yield=3.0 g, 73%, Mn=11530 g/mol.

Preparation of Compound I-6.

To a mixture of 2.96 g acrylic acid and 2.04 g 2-[[[(1,4-dihydro-6-methyl-4-oxo-2-pyrimidinyl)amino]carbonyl]amino]ethyl methacrylate, 0.11 g dimethyl-2,2′-azobisisobutyrat, 0.11 g 2-4-diphenyl-4-methyl-1-pentene and 44.77 g isopropanol were added. The mixture was degassed for 3 minutes and then heated at 90° C. for 6 hours under a stream of nitrogen. The product was collected by filtration, washed with acetone and dried. Yield=2.9 g, 58%, Mn=12400 g/mol.

1.2. Preparation of Compounds II-3, II-4/IV-1 and II-7.

### Preparation of N-(1,4-dihydro-6-methyl-4-oxo-2-pyrimidinyl)-N′-(6-isocyanatohexyl)urea

Based on procedure descibed in doctoral thesis “New Polymers Based On The Quadruple Hydrogen Bonding Motif” of B. J. B. Folmer, Technische Universiteit Eindhoven, 2000, page 95.

72.0 g hexamethylene diisocyanate was added to a 100 ml flask and heated under a nitrogen atmosphere to 80° C. To this mixture 12.0 g 2-Amino-4-hydroxy-6-methylpyrimidine was added. The mixture was then warmed to 100° C. and stirred for 20 hours. The mixture was then allowed to cool and the precipitate isolated by filtration and washing with n-hexane. Yield=27.3 g, 97%.

Preparation of Compound II-3.

The synthetic method is based on the method described in the following reference: H. M. Keizer, R. van Kessel, R. P. Sijbesma, E. W. Meijer, Polymer, 2003, 44, 5505.

A solution of 2.55 g polyethyleneglycol (Mn=300 g/mol) and 300 ml toluene was warmed to 60° C. and then 5.0 g N-(1,4-dihydro-6-methyl-4-oxo-2-pyrimidinyl)-N′-(6-isocyanatohexyl)urea was added together with 5 drops of dibutyltin dilaurate. The mixture was refluxed with stirring for 2.5 hours at 113° C., allowed to cool to 105° C., and then a further 1.05 g of then N-(1,4-dihydro-6-methyl-4-oxo-2-pyrimidinyl)-N′-(6-isocyanatohexyl)urea was added. Subsequently, the mixture was refluxed for a period of 5.5 hours. The mixture was allowed to cool to 105° C. and a further 0.12 g of then N-(1,4-dihydro-6-methyl-4-oxo-2-pyrimidinyl)-N′-(6-isocyanatohexyl)urea was added. The mixture was refluxed for a further 6.5 hours and then allowed to cool to room temperature. The solvent was removed in vacuum and the solid residue extracted with warm methoxypropanol. The solvent was removed from the extract and the resultant solid washed with ethyl acetate. Yield=4.5 g, 60%.

Preparation of Mixture of Compound II-4 and IV-1.

To a solution containing 6.0 g N-(1,4-dihydro-6-methyl-4-oxo-2-pyrimidinyl)-N′-(6-isocyanatohexyl)urea and 4.0 g polyethylene glycol (Mn=400g/mol) in 400 ml methylene chloride and 40 ml dimethylsulphoxide were added 5 drops of dibutyltin laurate. The mixture was then refluxed for 24 hours. The mixture was allowed to cool to room temperature and the precipitate removed by filtration. The filtrate was then reduced under vacuum to a solid which was then treated with ethyl acetate and n-hexane to produce a solid which was isolated by filtration. Yield=2.7 g.

Preparation of Compound II-7.

To a 500 ml flask 5.0 g N-(1,4-dihydro-6-methyl-4-oxo-2-pyrimidinyl)-N′-(6-isocyanatohexyl)urea, 5.1 g Jeffamine ED-600 (tradename of Huntsman Corporation, CASRN 65605-36-9), 40 ml methylene chloride, 40 ml dimethylsulphoxide and 5 drops of dibutyl tin dilaurate were added. The mixture was refluxed with stirring for 24 hours. An addition of 500 ml methanol followed by filtration and removal of solvent from the filtrate gave the required product which was washed with ethyl acetate and dried. Yield=9.2 g, 90%.

Preparation of the Coating Solutions.

### Example 1

A mixture of Compound II-4 and compound VI-1 was added to DMSO and the mixture was warmed to about 80° C. while stirring until a clear solution was obtained. IR-2 was added to this solution (Table 1).

### Examples 2, 3 and 4

Compound Type I-3, I-6 or I-7 was added to a mixture of THF, water and triethylamine. To this solution IR-1 was added (Table 1).

TABLE 1
Compositions of the coating solutions.

| Ingredients | Example 1 | Example 2 | Example 3 | Example 4 |
|---|---|---|---|---|
| Compound II-4 | 1.31 | — | — | — |
| g | | | | |
| Compound VI-1 | 0.34 | — | — | — |
| g | | | | |
| Compound I-3 | — | 0.5 | — | — |
| g | | | | |
| Compound I-6 | — | — | 0.5 | — |
| g | | | | |
| Compound I-7 | — | — | — | 0.5 |
| g | | | | |
| Tetrahydrofuran | — | 5.94 | 5.94 | 5.94 |
| ml | | | | |
| Dimethylsulfoxide | 48.6 | — | — | — |
| ml | | | | |
| Triethylamine | | 1.25 | 1.25 | 1.25 |
| ml | | | | |
| Water | | 5.94 | 5.94 | 5.94 |
| ml | | | | |
| IR-1 (1) | — | 1.88 | 1.88 | 1.88 |
| ml | | | | |
| IR-2 (2) | 0.25 | — | — | — |
| ml | | | | |

(1): 2% dispersion in water, infrared absorbing dye IR-1 has the following structure:

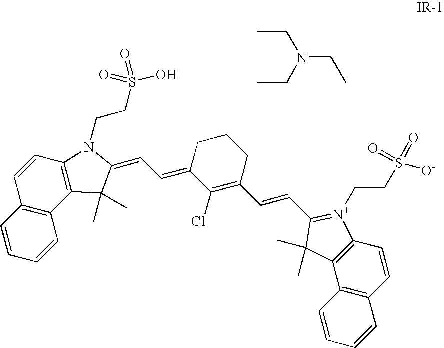

(2): 2% dispersion in water, infrared absorbing dye IR-2 has the following structure:

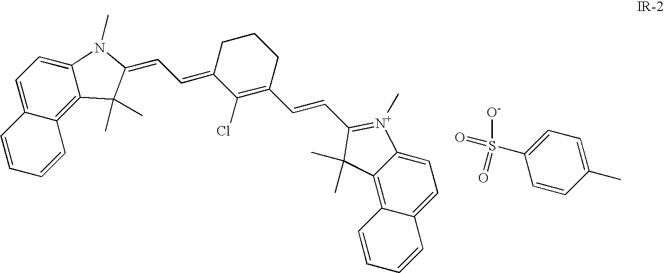

Preparation of the Printing Plates.

The coating solutions were coated with a bar-coater (thickness of layer of about 30 microns) onto an anodised aluminum plate at 40° C. and then dried for 10 minutes at 40° C. (Examples 2, 3 and 4) and at 95° C. (Example 1).

Print Results.

The plates were then exposed using an 830 nm IR laser (Isomet Diode) with the energy densities indicated in the Table 3 below.

TABLE 3
Applied Energy Densities.

| Power | Drumspeed | Energy density |
|---|---|---|
| mW | m/s | mJ/cm² |
| 4 | 200 | 714 |
| 4 | 140 | 500 |
| 4 | 100 | 357 |
| 8 | 200 | 357 |
| 8 | 100 | 179 |
| 8 | 60 | 107 |

The plate was then ready for printing. The printing test was performed on an off-set printing press GTO 46 (available from Heidelberger Druckmaschinen AG) using K+E NOVAVIT 800 SKINNEX ink (trademark of BASF Drucksysteme GmbH) and Agfa PRIMA FS101 fountain solution (trademark of Agfa). Minimum sensitivity is defined as the lowest energy at which a clear image is visible after 250 prints (Table 4).

TABLE 4
print results.

| | | Minimum |
|---|---|---|
| | Image Type | sensitivity* |
| Example 1 | Positive | 179 mJ/cm² |
| Example 2 | Negative | 714 mJ/cm² |
| Example 3 | Negative | 500 mJ/cm² |
| Example 4 | Negative | 357 mJ/cm² |

*the lowest energy at which a clear image is visible after 250 prints.

The results in Table 4 show that Example 1 results in a positive-working printing plate and that with Examples 2, 3. and 4, a negative working printing plate is obtained. The highest sensitivity is obtained for the positive working printing plate of Example 1.

While preferred embodiments of the present invention have been described above, it is to be understood that variations and modifications will be apparent to those skilled in the art without departing the scope and spirit of the present invention. The scope of the present invention, therefore, is to be determined solely by the following claims.

What is claimed is:

1. A method of lithographic printing comprising the steps of:
(i) providing a heat-sensitive lithographic printing plate precursor comprising, on a support having a hydrophilic surface or which is provided with a hydrophilic layer, a coating including a polymer modified with at least two QHB groups which can form quadruple hydrogen bonds;
(ii) exposing said printing plate precursor to at least one of heat and infrared light whereby the coating switches from a hydrophilic state into a hydrophobic state or from a hydrophobic state into a hydrophilic state, thereby producing a lithographic printing master without an intermediate wet development step; and
(iii) supplying at least one of ink and fountain solution to said lithographic printing master via a lithographic printing press.

2. The method according to claim 1, wherein at least one of the QHB groups is an isocytosinyl group.

3. The method according to claim 1, wherein the polymer is selected from QHB-modified phenolic resins, QHB-modified poly(meth)acrylates, QHB-modified polyesters, QHB-modified polyethers, QHB-modified polyurethanes or mixtures and copolymers thereof.

4. The method according to claim 2, wherein the polymer is selected from QHB-modified phenolic resins, QHB-modified poly(meth)acrylates, QHB-modified polyesters, QHB-modified polyethers, QHB-modified polyurethanes or mixtures and copolymers thereof.

5. The method according to claim 3, wherein the polymer is a QHB-modified polyether.

6. The method according to claim 5, wherein the molecular weight of the QHB-modified polyether is between about 100 g/mol and about 5,000 g/mol.

7. The method according to claim 5, wherein the QHB-modified polyether is selected from QHB-modified polyethylene oxide or QHB-modified polypropylene oxide or mixtures and copolymers thereof.

8. The method according to claim 6, wherein the QHB-modified polyether is selected from QHB-modified polyethylene oxide or QHB-modified polypropylene oxide or mixtures and copolymers thereof.

9. The method according to claim 3, wherein the polymer is a QHB-modified (meth)acrylate homopolymer or copolymer comprising a recurring unit including an isocytosinyl group in the side chain.

10. The method according to claim 9, wherein the QHB-modified (meth)acrylate homopolymer or copolymer has a molecular weight ranging from about 500 g/mol to about 500,000 g/mol.

11. A printing plate precursor comprising:
a support having a hydrophilic surface or which is provided with a hydrophilic layer; and
a coating including a polyether modified with at least two QHB groups which can form quadruple hydrogen bonds.

12. The printing plate precursor according to claim 11, wherein the QHB group is an isocytosinyl group.

13. The printing plate precursor according to claim 11, wherein the molecular weight of the modified polyether is between about 100 g/mol and about 5,000 g/mol.

14. The printing plate precursor according to claim 11, wherein the modified polyether is selected from QHB-modified polyethylene oxide or QHB-modified polypropylene oxide or mixtures thereof.
